(19) United States
(12) Patent Application Publication
(10) Pub. No.: US 2017/0031515 A1
(43) Pub. Date: Feb. 2, 2017

(54) INPUT DEVICE

(71) Applicant: SHARP KABUSHIKI KAISHA, Osaka (JP)

(72) Inventor: Mikihiro NOMA, Osaka (JP)

(73) Assignee: Sharp Kabushiki Kaisha, Osaka (JP)

(21) Appl. No.: 15/302,656

(22) PCT Filed: Apr. 8, 2015
(86) PCT No.: PCT/JP2015/060929

§ 371 Date: Oct. 7, 2016

(30) Foreign Application Priority Data
Apr. 15, 2014 (JP) 2014-083534

(51) Int. Cl. G06F 3/041; G06F 3/044; G06F 3/0481; G06F 3/01

(52) U.S. Cl. CPC G06F 3/0416; G06F 3/017; G06F 3/044; G06F 3/0412; G06F 3/04815; G06F 2203/04101

(57) ABSTRACT

An input device includes: a position detection unit that defines a detection region in a space in front of a prescribed reference surface and detects a position coordinate in the detection region of a detection object that has entered the detection region for an input operation on a coordinate axis perpendicular to the reference surface; and a processor that defines a virtual plane in parallel to the reference surface so as to partition the detection region in a direction of the coordinate axis, and that compares the position coordinate on the coordinate axis of the detection object as detected by the position detection unit with a position coordinate on the coordinate axis of the virtual plane, the processor further determining the input operation of the detection object in accordance with a result of the comparison.

### TECHNICAL FIELD

The present invention relates to an input device.

### BACKGROUND ART

As shown in Patent Document 1, a non-contact input device is known for which an input operation such as switching display images by a user moving his/her hand in a space in front of a display panel is performed. In this device, movements of the user's hand (that is, gestures) are captured by camera, and this image data is used to recognize gestures.

### RELATED ART DOCUMENT

### Patent Document

Patent Document 1: Japanese Patent Application Laid-Open Publication No. 2010-184600

### Problems to be Solved by the Invention

In gesture recognition using a camera, hand movement parallel to the surface of the display panel is easy to recognize, but hand movement perpendicular to the display surface (that is hand movement back and forth with respect to the display surface) is difficult to recognize due to reasons such as the difficulty in measuring distance of movement.

### SUMMARY OF THE INVENTION

An object of the present invention is to provide a non-contact input device having excellent input operability.

### Means for Solving the Problems

An input device of the present invention includes: a reference surface; a position detection unit that forms a detection region in a space in front of the reference surface and detects position coordinates in the detection region of a detection object such as a finger that has entered the detection region; a comparison unit that compares a position coordinate in a front-to-rear direction of a virtual plane set so as to partition the detection region front and rear, with a position coordinate in the front-to-rear direction of the detection object, the position coordinate having been detected by the position detection unit; and a determination unit that determines an input operation of the detection object on the basis of comparison results of the comparison unit.

By comparing a position coordinate in a front-to-rear direction of a virtual plane set so as to partition the detection region front and rear, with a position coordinate in the front-to-rear direction of the detection object, the position coordinate having been detected by the position detection unit, the input device can determine the input operation of the detection object. In other words, the input device can determine the input operation in the front-to-rear direction of the detection object, and has excellent input operability.

In the input device, when the comparison results by the comparison unit indicate that the position coordinate of the detection object is less than or equal to the position coordinate in the virtual plane, the determination unit may determine that the input operation is a click operation that passes through the virtual plane in a direction towards the reference surface.

Furthermore, an input device of the present invention includes: a reference surface; a position detection unit that forms a detection region in a space in front of the reference surface and detects position coordinates in the detection region of a detection object such as a finger that has entered the detection region; a virtual plane that partitions the detection region in a front-to-rear direction such that the detection region is divided into a first detection region and a second detection region; a standby detection unit that detects that the detection object has stayed in the second detection region for a prescribed time in accordance with detection results of the position detection unit; a change amount detection unit that detects, in accordance with the detection results of the position detection unit, an amount of change in position of the detection object from the second detection region towards the first detection region after staying in the second detection region for the prescribed time; and a determination unit that determines an input operation of the detection object in accordance with the detection results of the change amount detection unit.

In the input device, the detection region is divided front and rear into the first detection region and the second detection region by the virtual plane, and thus, the input device can determine the input operation in the front-to-rear direction of the detection object, and has excellent input operability.

Furthermore, an input device of the present invention includes: a reference surface; a position detection unit that forms a detection region in a space in front of the reference surface and detects position coordinates in the detection region of a detection object such as a finger that has entered the detection region; a virtual plane that partitions the detection region in a front-to-rear direction such that the detection region is divided into a first detection region and a second detection region; a standby detection unit that detects that the detection object has stayed in the first detection region for a prescribed time in accordance with detection results of the position detection unit; a change amount detection unit that detects, in accordance with the detection results of the position detection unit, an amount of change in position of the detection object from the first detection region towards the second detection region after staying in the first detection region for the prescribed time; and a determination unit that determines an input operation of the detection object on the basis of detection results of the change amount detection unit.

In the input device, the detection region is divided front and rear into the first detection region and the second detection region by the virtual plane, and thus, the input device can determine the input operation in the front-to-rear direction of the detection object, and has excellent input operability.

In the input device, the reference surface may be a display surface of a display unit that displays images.

The input device may include a display switching unit that switches an image displayed on the display surface of the display unit to another image corresponding to the input operation, on the basis of determination results of the determination unit.

Furthermore, an input device of the present invention includes: a display unit that displays a three-dimensional image so as to float in front of a display surface; a position detection unit that forms a detection region in a space in front of the display surface and detects position coordinates in the detection region of a detection object such as a finger that has entered the detection region; a comparison unit that compares a position coordinate in a front-to-rear direction of a virtual plane partitioning the detection region in the front-to-rear direction and overlapping a position of the three-dimensional image that floats in front of the display surface with a position coordinate in the front-to-rear direction of the detection object as acquired by the position detection unit; and a determination unit that determines an input operation of the detection object in accordance with comparison results of the comparison unit.

In the input device, the position of the virtual plane that partitions the detection region front and rear is set so as to overlap in position the three-dimensional image, which appears to float in front of the display surface of the display unit, and by the user performing an input operation in the front and rear direction using a finger or the like, the user can perform an input operation with the sense of directly touching the three-dimensional image.

In the input device, when the comparison results by the comparison unit indicate that the position coordinate of the detection object is less than or equal to the position coordinate in the virtual plane, the determination unit may determine that the input operation is a click operation that passes through the virtual plane in a direction towards the reference surface.

The input device may include a display switching unit that switches a three-dimensional image displayed so as to float in front of the display surface of the display unit to another three-dimensional image corresponding to the input operation, on the basis of determination results of the determination unit. If the three-dimensional image is switched to another three-dimensional image in this manner, the user can experience the sense of having switched the original three-dimensional image to the other three-dimensional image by directly touching the original three-dimensional image.

In the input device, it is preferable that the position detection unit have a sensor including a pair of electrodes for forming the detection region by an electric field, the position coordinates of the detection object being acquired on the basis of static capacitance between the electrodes. In other words, the position detection unit constituted by capacitance sensors or the like has excellent detection accuracy in the front and rear direction of the reference surface (or display surface) compared to other general modes of position detection units. Thus, it is preferable that a position detection unit including such capacitive sensors be used.

### Effects of the Invention

According to the present invention it is possible to provide a non-contact input device having excellent input operability.

### BRIEF DESCRIPTION OF THE DRAWINGS

FIG. 1 is a descriptive drawing that schematically shows the outer appearance of a display operation device of Embodiment 1.

FIG. 2 is a function block diagram showing main components of the display operation device of Embodiment 1.

FIG. 3 is a descriptive drawing that schematically shows an electric field distribution formed to the front of the display surface.

FIG. 4 is a descriptive drawing that schematically shows a signal strength of a capacitive sensor in the Z axis direction.

FIG. 5 is a flowchart showing steps of an input process of the display operation device based on a click operation by a fingertip.

FIG. 6 is a descriptive drawing that schematically shows a single click operation.

FIG. 7 is a descriptive drawing that schematically shows a double click operation.

FIG. 8 is a flowchart showing steps of an input process of the display operation device based on a forward movement operation by a fingertip.

FIG. 9 is a descriptive drawing that schematically shows a state in which a fingertip is held still in a second detection region prior to forward movement.

FIG. 10 is a descriptive drawing that schematically shows a state in which the fingertip moves forward to a first detection region.

FIG. 11 is a flowchart showing steps of an input process based on a backward movement operation by a fingertip.

FIG. 12 is a descriptive drawing that schematically shows a state in which a fingertip is held still in the first detection region prior to backward movement.

FIG. 13 is a descriptive drawing that schematically shows a state in which the fingertip moves backward to the second detection region.

FIG. 14 is a descriptive drawing that schematically shows the outer appearance of a display operation device of Embodiment 2.

FIG. 15 is a function block diagram showing main components of the display operation device of Embodiment 2.

FIG. 16 is a descriptive drawing that schematically shows the relationship between a three-dimensional image and a detection region formed to the front of the display operation device.

FIG. 17 is a flowchart showing steps of an input process of the display operation device based on a click operation by a fingertip.

FIG. 18 is a front view that schematically shows Modification Example 1 of electrodes included in the capacitive sensor.

FIG. 19 is a cross-sectional view along the line A-A of FIG. 18.

FIG. 20 is a front view that schematically shows Modification Example 2 of electrodes included in the capacitive sensor.

FIG. 21 is a cross-sectional view along the line B-B of FIG. 20.

### DETAILED DESCRIPTION OF EMBODIMENTS

### Embodiment 1

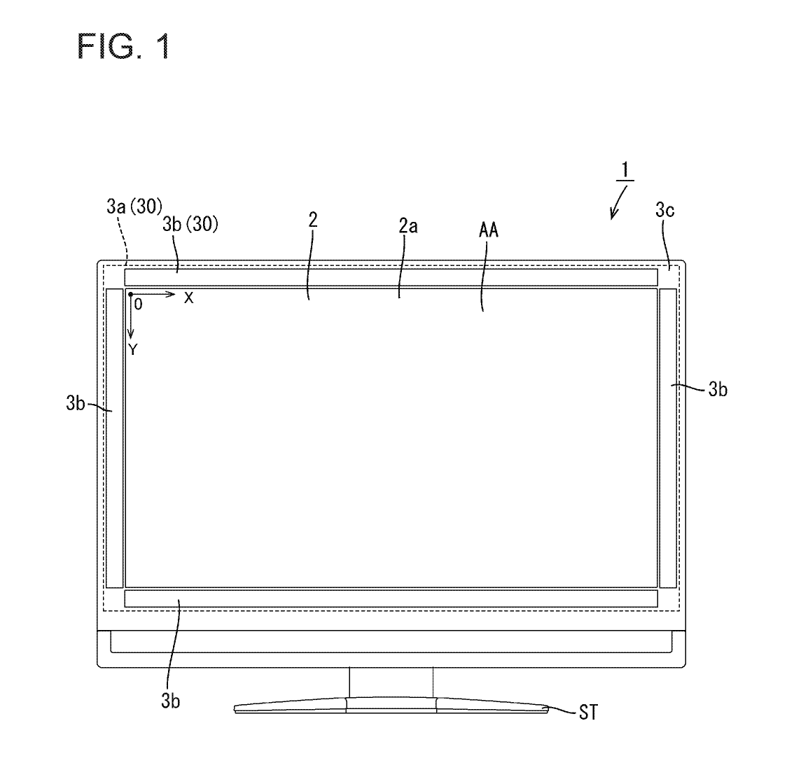

Embodiment 1 of the present invention will be explained below with reference to FIGS. 1 to 13. The present embodiment illustrates a display operation device 1 as an example of an input device. FIG. 1 is a descriptive drawing that schematically shows the outer appearance of a display operation device 1 of Embodiment 1. FIG. 1 shows the display operation device 1 as viewed from the front. In the display operation device 1, a user can directly operate an image displayed in the display surface 2a of the display unit 2 without touching the display surface 2a (reference surface) through hand motions (so-called gestures). The display unit 2 includes the horizontally long rectangular display surface 2a as shown in FIG. 1. Electrodes 3a and 3b used for detecting hand motions are provided in the periphery of the display surface 2a as will be described later. The display operation device 1 is supported by a stand ST.

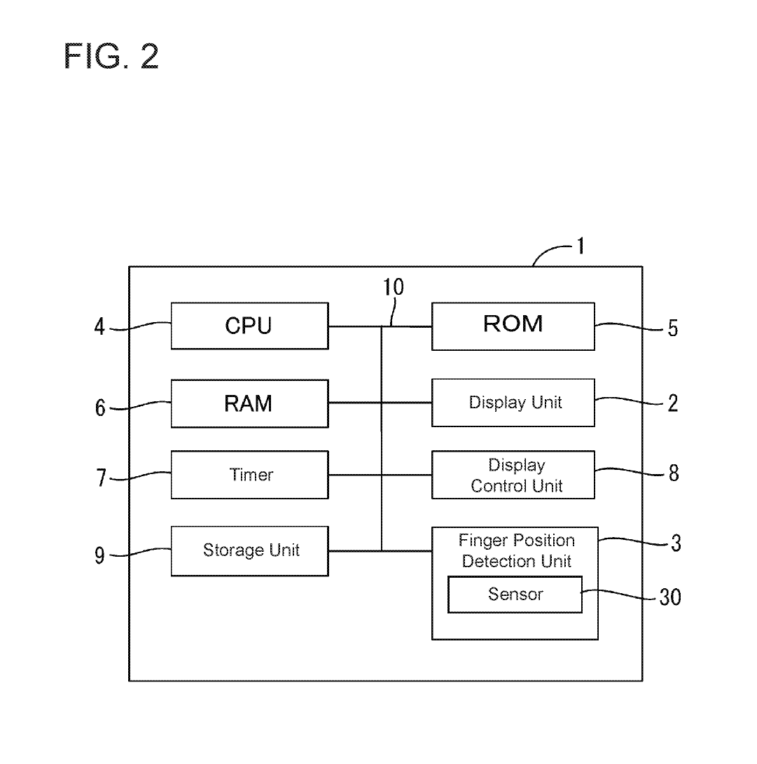

FIG. 2 is a function block diagram showing main components of the display operation device 1 of Embodiment 1. The display operation device 1 includes the display unit 2, a finger position detection unit 3 (position detection unit), a CPU 4, ROM 5, RAM 6, a timer 7, a display control unit 8 (display switching unit), a storage unit 9, and the like.

The CPU 4 (central processing unit) is connected to each hardware unit through a bus line 10. The ROM 5 (read-only memory) has stored in advance various control programs, parameters for computation, and the like. The RAM 6 (random access memory) is constituted by SRAM (static RAM), DRAM (dynamic RAM), flash memory, and the like, and temporarily stores various data generated when the CPU 4 executes various programs. The CPU 4 constitutes the determination unit, comparison unit, standby detection unit, change amount detection unit, and the like of the present invention.

The CPU 4 controls various pieces of hardware by loading control programs stored in advance in the ROM 5 onto the RAM 6 and executing the programs, and operates the device as a whole as the display operation device 1. Additionally, the CPU 4 receives process command input from a user through the finger position detection unit 3, as will be described later. The timer 7 measures various times pertaining to processes of the CPU 4. The storage unit 9 is constituted by a non-volatile storage medium such as flash memory, EEPROM, or HDD. The storage unit 9 has stored in advance various data to be described later (position coordinate data (threshold α, β) for a first virtual plane R1 and a second virtual plane R2, and prescribed time data such as Δt).

The display unit 2 is a display panel such as a liquid crystal display panel or an organic EL (electroluminescent) panel. Various information (images or the like) is displayed on the display surface 2a of the display unit 2 according to commands from the CPU 4.

The finger position detection unit 3 is constituted by a capacitive sensor 30, an integrated circuit such as a programmable system-on-chip, or the like, and detects position coordinates P (X coordinate, Y coordinate, Z coordinate) of a user's fingertip located in front of the display surface 2a. In the present embodiment, the origin of the coordinate axes is set to the upper left corner of the display surface 2a as seen from the front, with the left-to-right direction being a positive direction along the X axis and the up-to-down direction being a positive direction along the Y axis. The direction perpendicular to and moving away from the display surface 2a is a positive direction along the Z axis. The position coordinates P of the fingertips or the like to be detected, which are acquired by the position detection unit 3, are stored as appropriate in the storage unit 9. The CPU 4 reads the position coordinate P data from the storage unit 9 as necessary, and performs computations using such data.

As shown in FIG. 1, the finger position detection unit 3 includes the pair of electrodes 3a, 3b for detecting the fingertip position coordinates P. One of the electrodes 3a is a transmitter electrode 3a (drive-side electrode), and has a frame shape surrounding a display area AA (active area) of the display surface 2a. A transparent thin-film electrode member is used as the transmitter electrode 3a. A transparent insulating layer 3c is formed on the transmitter electrode 3a. The other electrodes 3b are receiver electrodes 3b that are disposed in the periphery of the display surface 2a so as to overlap the transmitter electrode 3a across the transparent insulating layer 3c. In the present embodiment, there are four receiver electrodes 3b, which are respectively disposed on all sides of the rectangular display surface 2a. The electrodes 3a and 3b are set so as to face the same direction (Z axis direction) as the display surface 2a.

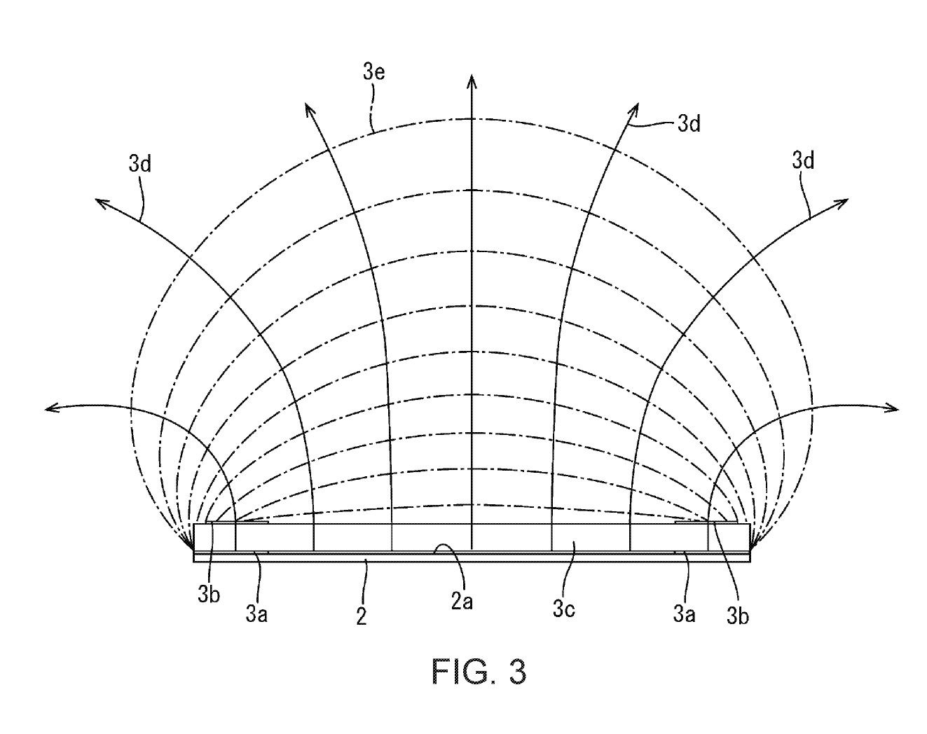

FIG. 3 is a descriptive drawing that schematically shows an electric field distribution formed to the front of the display surface 2a. When a voltage is applied between the electrodes 3a and 3b, an electric field having a prescribed distribution is formed to the front of the display surface 2a. FIG. 3 schematically shows electric force lines 3d and equipotential lines 3e. In this manner, the space to the front of the display surface 2a where the electric field is formed is a region (detection region F) where a detection object such as a fingertip is detected by the finger position detection unit 3. If a fingertip or the like to be detected enters this region, then the capacitance between the electrodes 3a and 3b changes. The capacitive sensor 30 including the electrodes 3a and 3b forms a prescribed capacitance between the electrodes 3a and 3b according to the entry of a fingertip in the region, and outputs an electric signal corresponding to this capacitance. The finger position detection unit 3 can detect the capacitance formed between the electrodes 3a and 3b on the basis of this output signal, and can additionally calculate the position coordinates P (X coordinate, Y coordinate, Z coordinate) of the fingertip in the detection region on the basis of this detection result. The detection of the position coordinates P of the fingertip by the finger position detection unit 3 is executed steadily, repeating at a uniform time interval. A well-known method is employed to calculate the fingertip position coordinates P from the capacitance formed between the electrodes 3a and 3b.

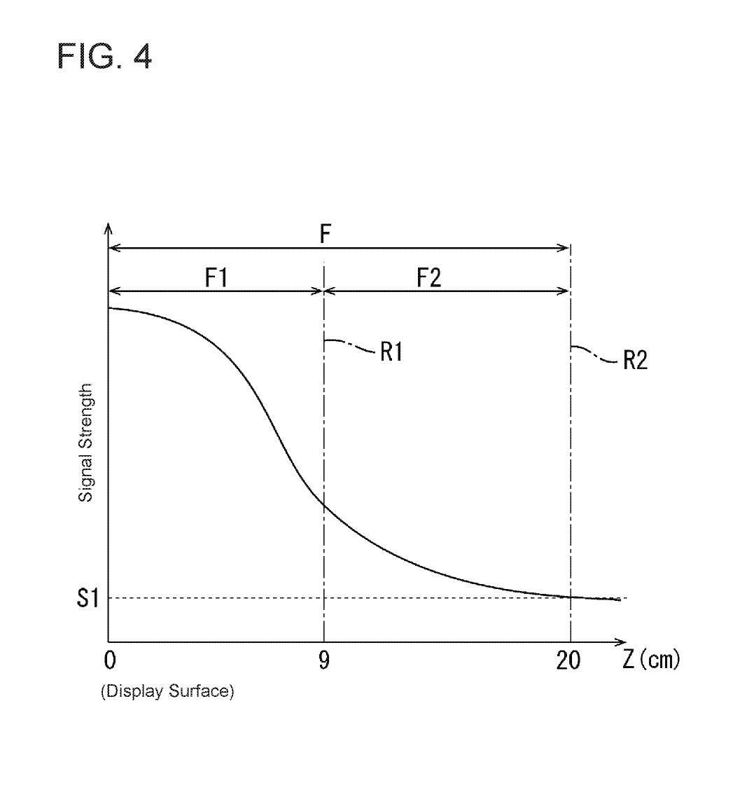

FIG. 4 is a descriptive drawing that schematically shows a signal strength of the capacitive sensor 30 in the Z axis direction. In the present embodiment, the display surface 2a has a 7-inch diagonal size, and if the drive voltage of the capacitive sensor 30 is set to 3.3V, then the signal value (S1) at the detection limit is at approximately 20 cm (greater than 20 cm) in the Z axis direction from the display surface 2a. In the present embodiment, the rectangular cuboid space measured out as the (length in the horizontal direction (X axis direction) of the display surface 2a)×(vertical direction (Y axis direction) length of the display surface 2a)×(length (20 cm) in the Z axis direction) is set as the detection region F.

The detection region F has two virtual planes having, respectively, uniform Z axis coordinates. One of the virtual planes is a first virtual plane R1 set at a position 9 cm from the display surface 2a in the Z axis direction, and the other virtual plane is a second virtual plane R2 that is set at a position 20 cm from the display surface 2a in the Z axis direction. In the present embodiment, the second virtual plane R2 is set at the Z coordinate detection limit. The first virtual plane R1 is set between the display surface 2a and the second virtual plane R2.

The detection region F is partitioned into two spaces by the first virtual plane R1. In the present specification, the space in the detection region F from the first virtual plane R1 to the display surface 2a (between the display surface 2a and the first virtual plane R1) is referred to as the first detection region F1. The space between the first virtual plane R1 and the second virtual plane R2 is referred to as the second detection region F2. The first detection region F1 is used, for example, in order to detect click operations based on fingertip movements in the Z axis direction as will be described later. By contrast, the second detection region F2 is used in order to detect input operations based on fingertip movements in the Z axis direction or operations based on fingertip movements in the X axis direction and Y axis direction (flick movements, for example) as will be described later. In this manner, the detection region F is divided into two detection regions F1 and F2 in sequential order according to distance from the display surface 2a (reference surface).

The CPU 4 recognizes finger movements by the user by comparing fingertip position coordinates P detected by the finger position detection unit 3 with various preset thresholds (a, etc.), and receives processing content that has been placed in association with such movements in advance. Furthermore, in order to execute the received processing content, the CPU 4 controls respective target units (such as the display control unit 8).

The display control unit 8 displays a prescribed image in the display unit 2 according to commands from the CPU 4. The display control unit 8 reads appropriate information from the storage unit 9 according to commands from the CPU 4 corresponding to fingertip movements by the user (such as changes in Z coordinate of the fingertip), and controls the image displayed in the display unit 2 so as to switch to an image based on the read-in information. The display control unit 8 may be a software function realized by the CPU 4 executing a control program stored in the ROM 5, or may be realized by a dedicated hardware circuit. The display operation device 1 of the present embodiment may include an input unit (button-type input unit) or the like that is not shown.

The steps of the input process based on movements (Z axis direction movements) of a user U's fingertip in the display operation device 1 of the present embodiment will be described. The content indicated below is one example of an input process based on movements of the user U's fingertip (Z axis direction movements), and the present invention is not limited to such content. First, the steps of an input process based on two types of click operations (single click and double click) will be described.

(Input Operation by Click Movement)

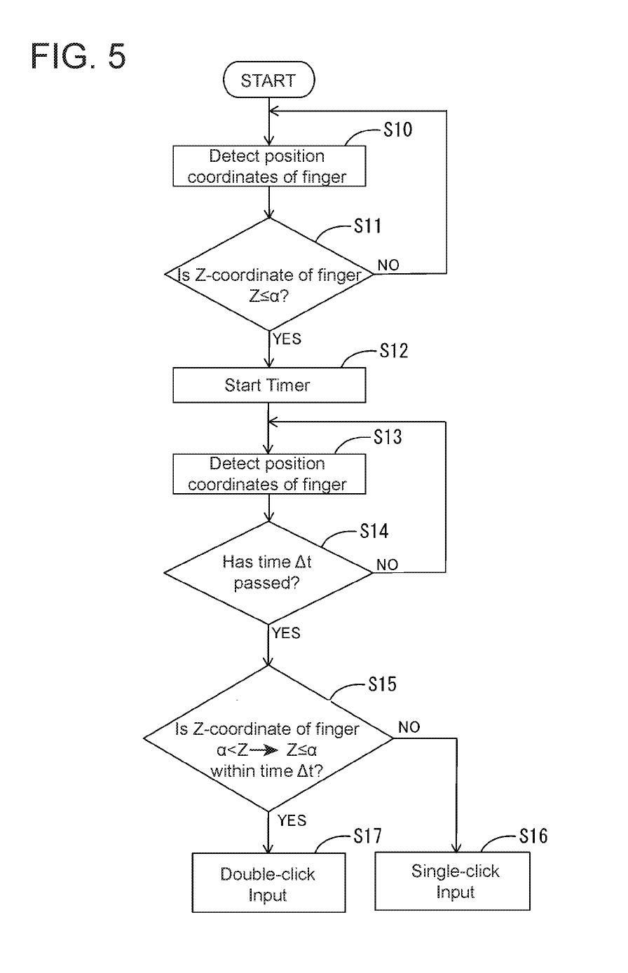

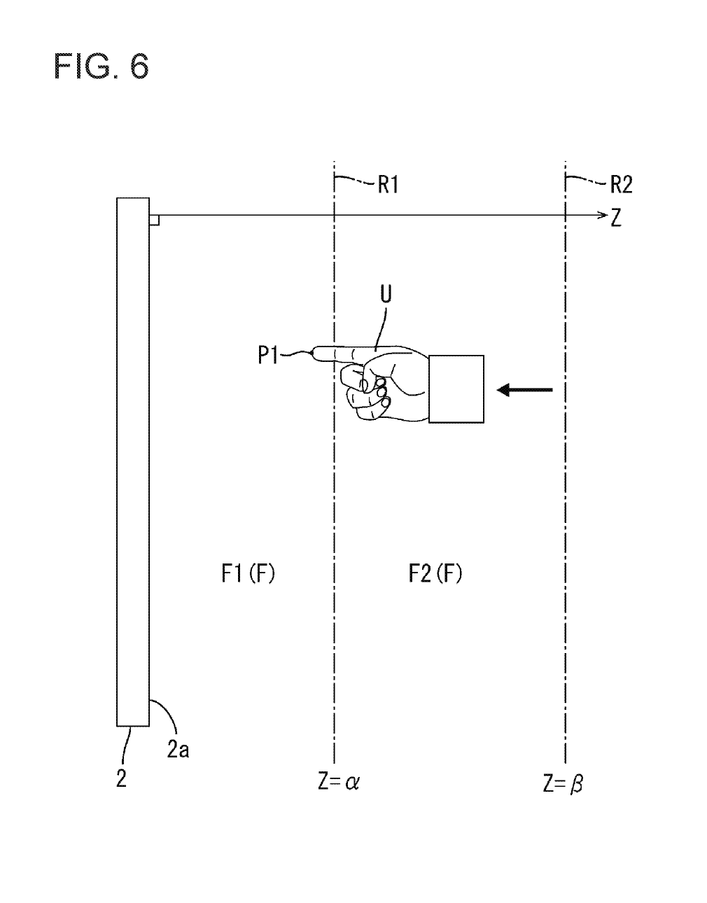

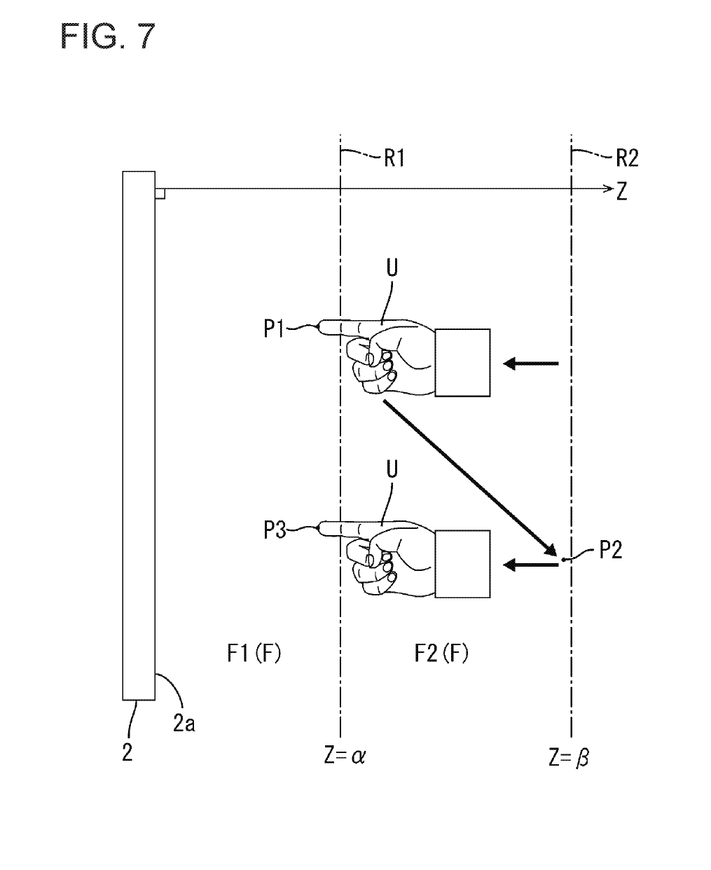

FIG. 5 is a flowchart showing steps of an input process of the display operation device 1 based on a click operation by a fingertip, FIG. 6 is a descriptive drawing that schematically shows a single click operation, and FIG. 7 is a descriptive drawing that schematically shows a double click operation. Before entering an input by click operation, the user U first performs a prescribed operation on the display operation device 1 and causes the CPU 4 to execute a process of displaying a prescribed reception image (not shown) in the display surface 2a of the display unit 2.

In step S10, the finger position detection unit 3 acquires the fingertip position coordinates P of the user U according to a command from the CPU 4. When a finger enters the detection region F, in step S10, the finger position detection unit 3 acquires the fingertip position coordinates P (X coordinate, Y coordinate, Z coordinate). In the present embodiment, as shown in FIGS. 6 and 7, the user U's hand is formed such that only the index finger extends towards the display surface 2a from a clenched hand. Thus, the position coordinate of the tip of the index finger is acquired by the finger position detection unit 3. Regarding movements of the user U's hand (finger) for input operations on the display operation device 1, a case in which the hand approaches the display surface 2a is referred to as “forward movement” and a case in which the hand moves away from the display surface 2 is referred to as “backward movement”.

After the fingertip position coordinates P are acquired, the CPU 4 determines in step S11 whether the Z coordinate among the acquired position coordinates P is less than or equal to a preset threshold α. The threshold α is the Z coordinate of the first virtual plane R1, and indicates a position 9 cm away from the display surface 2a in the Z axis direction. If the Z coordinate among the acquired position coordinates P is greater than the threshold α (Z>α), then the process returns to step S10. If the Z coordinate among the acquired position coordinates P is less than or equal to the threshold α (Z≦α), then the process progresses to step S12. As shown in FIGS. 6 and 7, if the fingertip crosses the first virtual plane R1 and enters the first detection region F1, then the Z coordinate (Z1) among the fingertip position coordinates P1 is less than or equal to α.

The detection of the position coordinates P of the fingertip by the finger position detection unit 3 is executed steadily, repeating at a uniform time interval, regardless of the presence or absence of a detection object (finger) in the detection region F. Every time the detection of position coordinates P is performed, the process progresses to step S11, and as described above, the CPU 4 compares the detection results (Z coordinate) with the threshold α.

In step S12, the CPU 4 starts the timer 7 and measures the time. Then, in step S13, detection of the fingertip position coordinates P is performed again, as in step S10. After detection of the position coordinates P, the CPU 4 determines whether or not a preset prescribed time Δt has elapsed since the timer 7 has started. If the CPU 4 has determined that the prescribed time Δt has not elapsed, then the process returns to step S13 and detection of the position coordinates P of the finger is once again performed. By contrast, if the CPU 4 has determined that the prescribed time Δt has elapsed, then the process progresses to step S15. In other words, after the timer 7 has started with the fingertip entering the first detection region F1, the finger position detection unit 3 repeatedly performs detection of the fingertip position coordinates P until the prescribed time Δt has elapsed. In the present embodiment, the prescribed time Δt, the detection interval and the like for the position coordinates P are set such that the detection of the fingertip position coordinates P in step S13 is performed a plurality of times (twice or more).

In step S15, after the Z coordinate among the fingertip position coordinates P reaches α<Z within the prescribed time Δt, the CPU 4 once again determines whether Z has reached Z≦α. As shown in FIG. 6, if the fingertip crosses the first virtual plane R1 and enters the first detection region F1 for a period of Δt, then the Z coordinate among the position coordinates P is always less than or equal to α. In such a case, the process progresses from step S15 to S16, and the movement of the user U's fingertip (Z axis direction movement) in the detection region F is recognized as a single click operation, and a process associated therewith in advance is executed. In the present embodiment, by such a click operation (single click operation), a command is inputted to the display operation device 1 so as to switch the above-mentioned reception image (not shown) to another image (not shown), for example.

By contrast, as shown in FIG. 7, if during the prescribed time Δt the fingertip moves backward towards the second detection region F2 (position coordinate P2) and then once again crosses the first virtual plane R1 and enters the first detection region F1 (position coordinate P3), the Z coordinate of the fingertip position coordinates P, after attaining α<Z, once again becomes Z≦α. In other words, the Z coordinate (Z2) among the position coordinates P2 is at α<Z2, and the Z coordinate (Z3) among the position coordinates P3 is at Z3≦α. In such a case, the process progresses from step S15 to S17, and the movement of the user U's fingertip (Z axis direction movement) in the detection region F is recognized as a double click operation, and a process associated therewith in advance is executed. In the present embodiment, by such a click operation (double click operation), a command is inputted to the display operation device 1 so as to switch the above-mentioned reception image (not shown) to another image (not shown), for example.

In such a display operation device 1, the Z coordinate of the first virtual plane R1 set in the detection region F is used as the threshold α for recognizing a click operation (movement of user U's finger in the Z axis direction). Thus, the user U can use the first virtual plane R1 as the “click surface” to input clicks, and by movement back and forth of the fingertip (movement along the Z axis direction), it is possible to perform input operations with ease on the display operation device 1 without directly touching the display unit 2. In the display operation device 1 of the present embodiment, the amount of data that the CPU 4 needs to process is less than in conventional devices where user gestures were recognized by analyzing image data.

(Input Operation by Forward Movement)

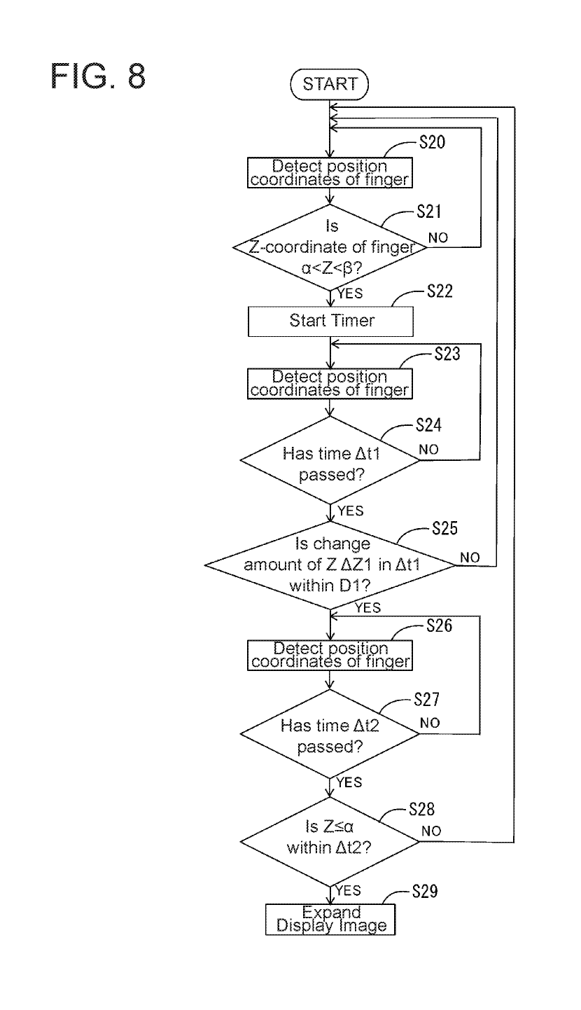

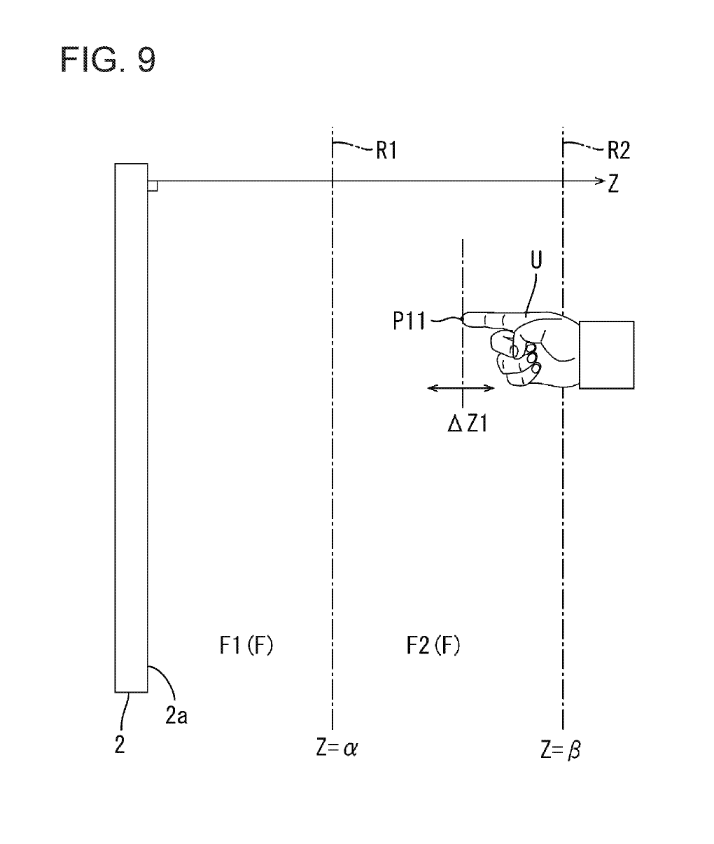

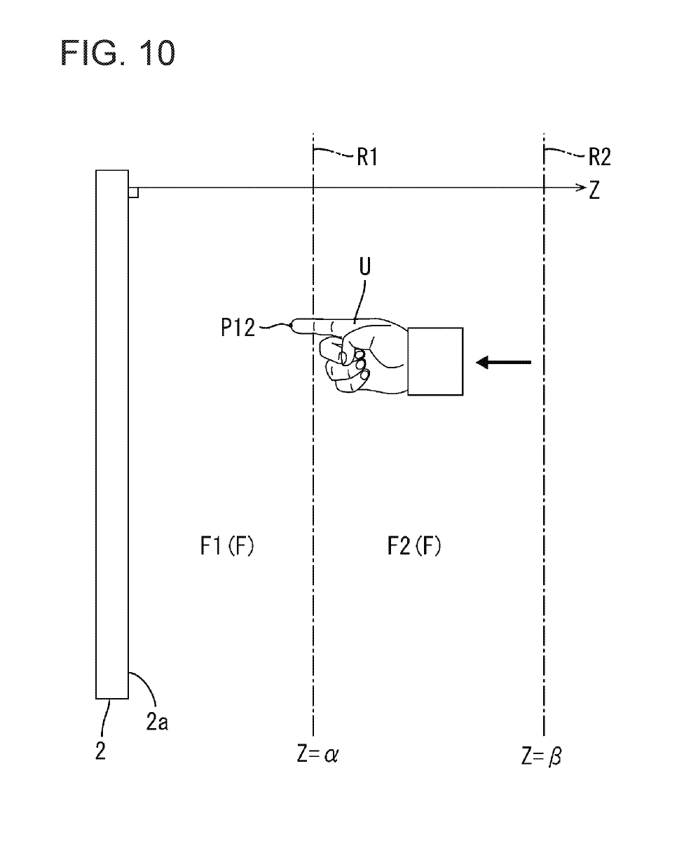

Next, the steps of the input process based on forward movement of the user U's fingertip will be described. In the present embodiment, a command in which the image displayed in the display unit 2 is switched to an enlarged image is inputted to the display operation device 1 by forward movement of the fingertip. FIG. 8 is a flowchart showing steps of an input process of the display operation device 1 based on a forward movement operation by a fingertip, FIG. 9 is a descriptive drawing that schematically shows a state in which a fingertip is held still in the second detection region F2 prior to forward movement, and FIG. 10 is a descriptive drawing that schematically shows a state in which the fingertip moves forward to the first detection region F1.

Before entering an input by forward movement to increase magnification of the display, the user U first performs a prescribed operation on the display operation device 1 and causes the CPU 4 to execute a process of displaying a prescribed image (not shown) in the display surface 2a of the display unit 2.

Next, in step S20, the finger position detection unit 3 acquires the fingertip position coordinates P of the user U according to a command from the CPU 4. After the fingertip position coordinates P are acquired, the CPU 4 determines in step S21 whether the Z coordinate among the acquired position coordinates P is within a preset range (α<Z<β). The threshold α is as described above. The threshold β is the Z coordinate of the second virtual plane R2, and indicates a Z coordinate corresponding to a distance of 20 cm away from the display surface 2a in the Z axis direction. By using such thresholds α and β, it can be determined whether the fingertip position coordinates P are within the second detection region F2.

If as shown in FIG. 9 the user U's fingertip is within the second detection region F2, for example, then the Z coordinate of the fingertip among the position coordinates P11 satisfies α<Z<β. If the Z coordinate among the acquired fingertip position coordinates P is within this range, then the process progresses to step S22. By contrast, if the Z coordinate among the acquired fingertip position coordinates P is outside of this range, then the process progresses to step S20, and detection of the finger position coordinates P is once again performed.

The detection of the position coordinates P of the fingertip by the finger position detection unit 3 is, as described above, executed steadily, repeating at a uniform time interval, regardless of the presence or absence of a detection object (finger) in the detection region F. Every time the detection of position coordinates P is performed, the process progresses to step S21.

In step S22, the CPU 4 starts the timer 7 and measures the time. Then, in step S23, detection of the fingertip position coordinates P is performed again, as in step S20. After detection of the position coordinates P, the CPU 4 determines whether or not a preset prescribed time Δt1 (3 seconds, for example) has elapsed since the timer 7 has started. If the CPU 4 has determined that the prescribed time Δt1 has not elapsed, then the process returns to step S23 and detection of the position coordinates P of the finger is once again performed. By contrast, if the CPU 4 has determined that the prescribed time Δt1 has elapsed, then the process progresses to step S25. In other words, after the timer 7 has started with the fingertip entering the second detection region F2, the finger position detection unit 3 repeatedly performs detection of the fingertip position coordinates P until the prescribed time Δt1 has elapsed. The timer 7, in addition to being used to measure the prescribed time Δt1, is also used to measure the prescribed time Δt2 to be described later.

In step S25, the CPU 4 determines whether or not the Z coordinate among the plurality of position coordinates P detected within the prescribed time Δt1 is within an allowable range D1 (±0.5 cm, for example) for which a change amount ΔZ1 is set in advance. The change amount ΔZ1 is determined in step S21 by taking the difference between the Z coordinate (reference value) determined to satisfy the range α<Z<β, and the Z coordinate among the position coordinates P detected within the prescribed time Δt1. If all change amounts ΔZ1 for Z coordinates of all position coordinates P detected after the timer 7 has started are within the allowable range D1, then the process progresses to step S26. By contrast, if the change amount ΔZ1 of even one Z coordinate exceeds the allowable range D1, then the process returns to step S20. In other words, in step S25, it is determined whether or not the fingertip of the user U is within the second detection region F2 and has stopped moving at least in the Z axis direction.

In step S26, detection of the fingertip position coordinates P is performed again. As indicated in step S27, such detection is repeated until the prescribed time Δt2 has elapsed since the timer 7 has started. The prescribed time Δt2 is longer than the prescribed time Δt1, and if Δt1 is set to 3 seconds, then Δt2 is set to 3.3 seconds, for example. If the CPU 4 has determined that the prescribed time Δt2 has elapsed, then the process progresses to step S28.

In step S28, the CPU 4 determines whether the Z coordinates among the plurality of position coordinates P detected within the prescribed time Δt2 have become less than or equal to α (Z≦α). In other words, in step S28, it is determined whether the user U's fingertip has moved (forward) from the second detection region F2 to the first detection region F1 within Δt2−Δt1 (0.3 seconds, for example). If as shown in FIG. 10 the user U's fingertip is within the second detection region F2 for the prescribed time Δt1 and then moves forward and enters the first detection region F1 by Δt2, for example, then the Z coordinate of the fingertip among the position coordinates P12 becomes less than or equal to α (Z≦α). In another embodiment, it may be determined whether the Z coordinates among the plurality of position coordinates P detected during Δt2−Δt1 (0.3 seconds, for example) have become less than or equal to α (Z≦α).

In step S28, if the CPU 4 determines that there are no Z coordinates at or below α (Z≦α), then the process progresses to step S20. By contrast, if in step S28 the CPU 4 determines that there is at least one Z coordinate at or below α (Z≦α), then the process progresses to step S29. In step S29, the CPU 4 receives a command to switch the image displayed in the display unit 2 to an enlarged image. A command in which the image displayed in the display unit 2 is switched to an enlarged image can be inputted to the display operation device 1 by such forward movement of the user U's fingertip (example of a gesture). When the CPU 4 receives such an input, the display control unit 8 reads information pertaining to an enlarged image from the storage unit 9 and then switches from an image displayed in advance in the display unit 2 to the enlarged image on the basis of the read-in information, according to the command from the CPU 4. In such a display operation device 1, it is possible for an input operation to be performed with ease by forward movement of the user U's fingertip (movement of fingertip in Z axis direction) without directly touching the display unit 2.

(Input Operation by Backward Movement)

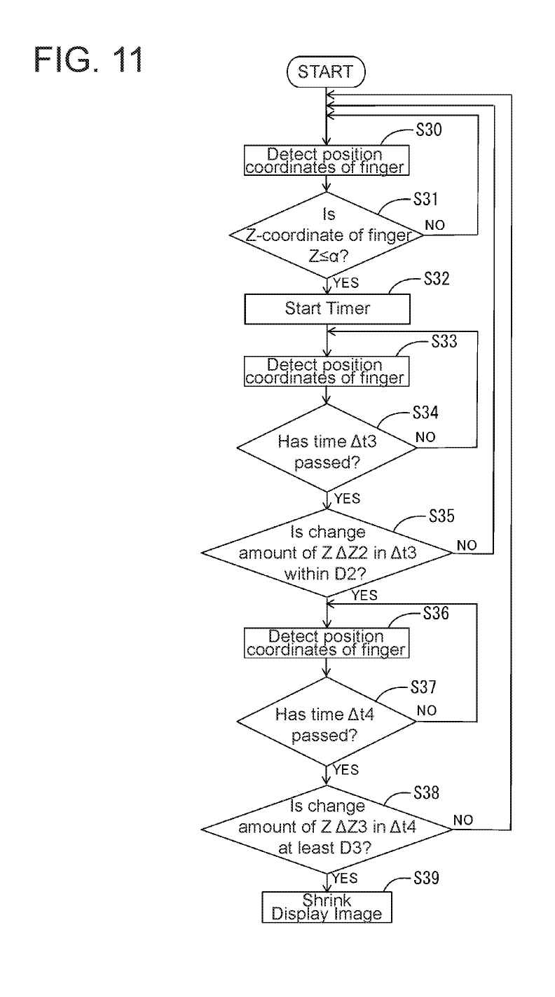

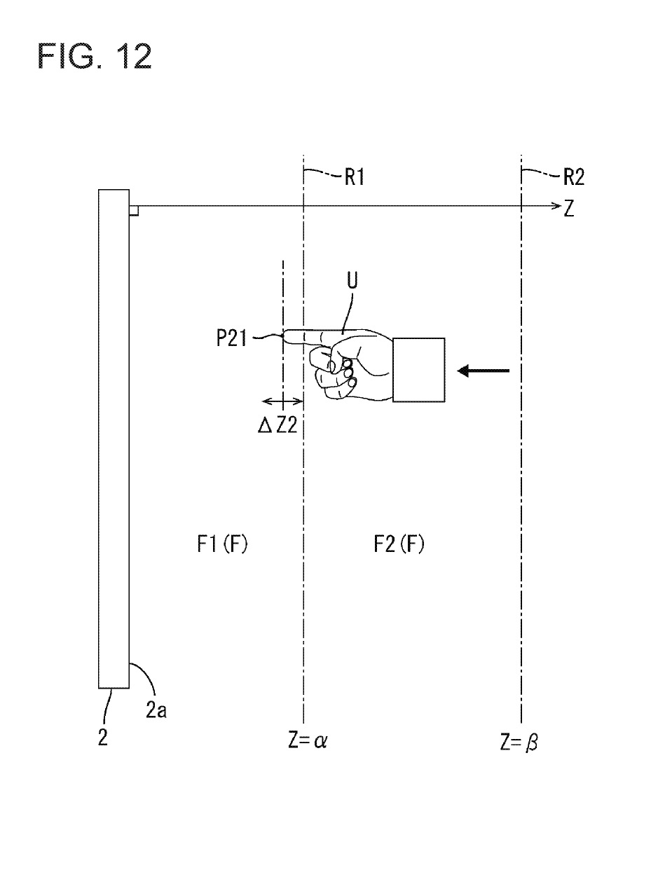

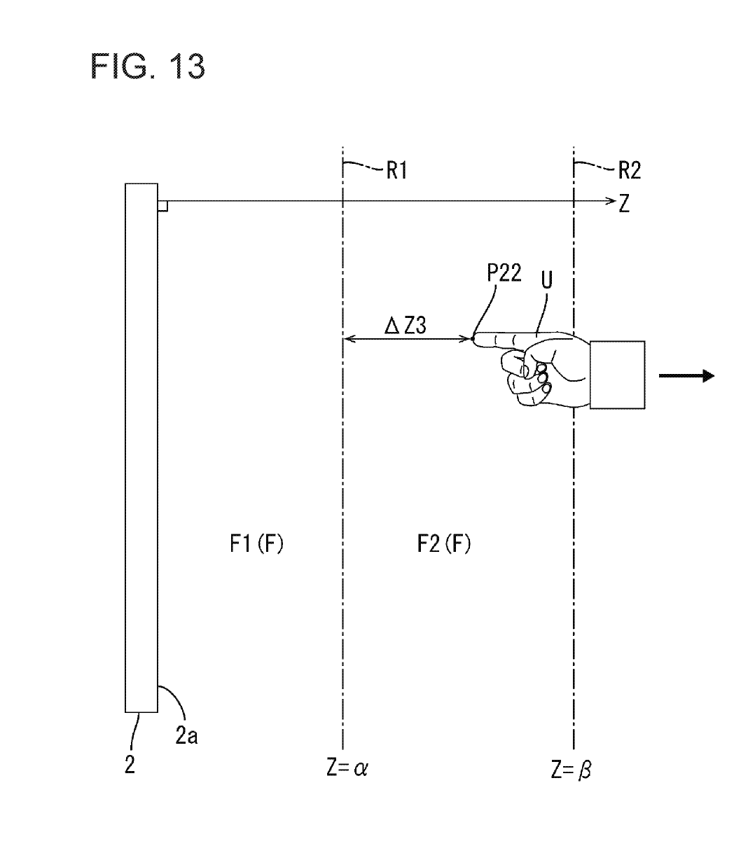

Next, the steps of the input process based on backward movement of the user U's fingertip will be described. In the present embodiment, a command in which the image displayed in the display unit 2 is switched to a shrunken image is inputted to the display operation device 1 by backward movement of the fingertip. FIG. 11 is a flowchart showing steps of an input process of the display operation device 1 based on a backward movement operation by a fingertip, FIG. 12 is a descriptive drawing that schematically shows a state in which a fingertip is held still in the first detection region F1 prior to backward movement, and FIG. 13 is a descriptive drawing that schematically shows a state in which the fingertip moves backward to the second detection region F2.

Before entering an input by backward movement to decrease magnification of the display, the user U first performs a prescribed operation on the display operation device 1 and causes the CPU 4 to execute a process of displaying a prescribed image (not shown) in the display surface 2a of the display unit 2.

Next, in step S30, the finger position detection unit 3 acquires the fingertip position coordinates P of the user U according to a command from the CPU 4. After the fingertip position coordinates P are acquired, the CPU 4 determines in step 31 whether the Z coordinate among the acquired position coordinates P is within a preset range (Z≦α). The threshold α is as described above. By using such a threshold α, it can be determined whether the fingertip position coordinates P are within the first detection region F1.

If as shown in FIG. 12 the user U's fingertip is within the first detection region F1, for example, then the Z coordinate of the fingertip among the position coordinates P21 satisfies Z≦α. If the Z coordinate among the acquired fingertip position coordinates P is within this range, then the process progresses to step S32. By contrast, if the Z coordinate among the acquired fingertip position coordinates P is outside of this range, then the process progresses to step S30, and detection of the finger position coordinates P is once again performed.

The detection of the position coordinates P of the fingertip by the finger position detection unit 3 is, as described above, executed steadily, repeating at a uniform time interval, regardless of the presence or absence of a detection object (finger) in the detection region F. Every time the detection of position coordinates P is performed, the process progresses to step S31.

In step S32, the CPU 4 starts the timer 7 and measures the time. Then, in step S33, detection of the fingertip position coordinates P is performed again, as in step S30. After detection of the position coordinates P, the CPU 4 determines whether or not a preset prescribed time Δt3 (3 seconds, for example) has elapsed since the timer 7 has started. If the CPU 4 has determined that the prescribed time Δt3 has not elapsed, then the process returns to step S33 and detection of the position coordinates P of the finger is once again performed. By contrast, if the CPU 4 has determined that the prescribed time Δt3 has elapsed, then the process progresses to step S35. In other words, after the timer 7 has started with the fingertip entering the first detection region F1, the finger position detection unit 3 repeatedly performs detection of the fingertip position coordinates P until the prescribed time Δt3 has elapsed. The timer 7, in addition to being used to measure the prescribed time Δt3, is also used to measure the prescribed time Δt4 to be described later.

In step S35, the CPU 4 determines whether or not the Z coordinate among the plurality of position coordinates P detected within the prescribed time Δt3 is within an allowable range D2 (±0.5 cm, for example) for which a change amount ΔZ2 is set in advance. The change amount ΔZ2 is determined in step S31 by taking the difference between the Z coordinate (reference value) determined to satisfy the range Z≦α, and the Z coordinate among the position coordinates P detected within the prescribed time Δt13. If all change amounts ΔZ2 for Z coordinates of all position coordinates P detected after the timer 7 has started are within the allowable range D2, then the process progresses to step S36. By contrast, if the change amount ΔZ2 of even one Z coordinate exceeds the allowable range D2, then the process returns to step S30. In other words, in step S35, it is determined whether or not the fingertip of the user U is within the first detection region F1 and has stopped moving at least in the Z axis direction.

In step S36, detection of the fingertip position coordinates P is performed again. As indicated in step S37, such detection is repeated until the prescribed time Δt4 has elapsed since the timer 7 has started. The prescribed time Δt4 is longer than the prescribed time Δt3, and if Δt3 is set to 3 seconds, then Δt4 is set to 3.3 seconds, for example. If the CPU 4 has determined that the prescribed time Δt4 has elapsed, then the process progresses to step S38.

In step S38, the CPU 4 determines whether or not there is at least one case in which a difference ΔZ3 between the Z coordinate among the plurality of position coordinates P detected within the prescribed time Δt4 and the Z coordinate of the first virtual plane R1 (that is, α) is greater than or equal to a predetermined prescribed value D3 (3 cm, for example). In other words, in step S38, it is determined whether the user U's fingertip has moved (forward) from the first detection region F1 to the second detection region F2 within Δt4−Δt3 (0.3 seconds, for example). In another embodiment, it may be determined whether there is at least one case in which a difference ΔZ3 between the Z coordinates among the plurality of position coordinates P detected during Δt4−Δt3 (0.3 seconds, for example), and α is greater than or equal to a predetermined prescribed value D3.

After the fingertip of the user U stays in the first detection region F1 for the prescribed time Δt3 as shown in FIG. 12, the fingertip moves back by Δt4 to a position (position coordinate P22) that is at a distance of the prescribed value D3 or greater from the first virtual plane R1 along the Z axis direction as shown in FIG. 13, for example. In step S38, if the CPU 4 determines that if there are no cases in which the difference ΔZ3 is greater than or equal to the prescribed value D3, then the process progresses to step S30. By contrast, if in step S38 the CPU 4 determines that if there is at least one case in which the difference ΔZ3 is greater than or equal to the prescribed value D3, then the process progresses to step S39.

In step S39, the CPU 4 receives a command (input) to switch the image displayed in the display unit 2 to a shrunken image. A command in which the image displayed in the display unit 2 is switched to a shrunken image can be inputted to the display operation device 1 by such backward movement of the user U's fingertip (example of a gesture). When the CPU 4 receives such an input, the display control unit 8 reads information pertaining to a shrunken image from the storage unit 9 and then switches from an image displayed in advance in the display unit 2 to the shrunken image on the basis of the read-in information, according to the command from the CPU 4. In such a display operation device 1, it is possible for an input operation to be performed with ease by backward movement of the user U's fingertip (movement of fingertip in Z axis direction) without directly touching the display unit 2.

### Embodiment 2

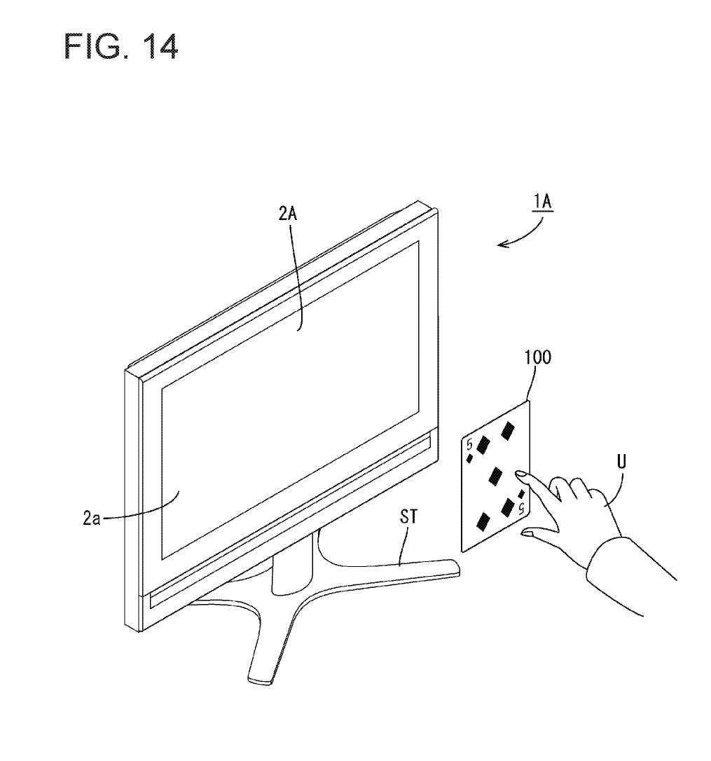

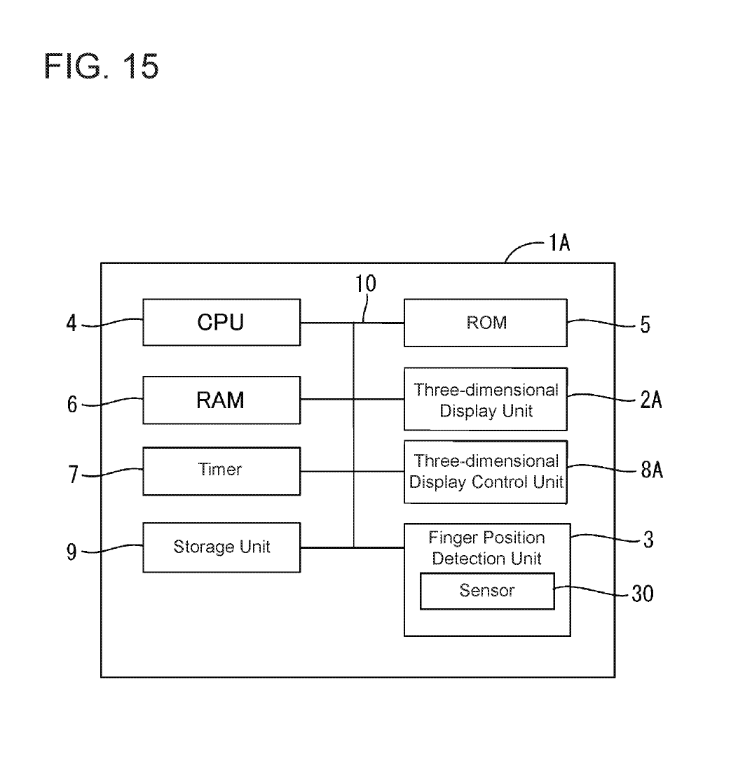

Next, a display operation device 1A of Embodiment 2 will be described with reference to FIGS. 14 to 17. FIG. 14 is a descriptive drawing that schematically shows the outer appearance of a display operation device 1A of Embodiment 2, and FIG. 15 is a function block diagram showing main components of the display operation device 1A of Embodiment 2. The display operation device 1A of the present embodiment includes a three-dimensional image display unit 2A instead of the display unit 2 of the display operation device 1 of Embodiment 1, and has a three-dimensional image display control unit 8A instead of the display control unit 8. Furthermore, the display operation device 1A of the present embodiment stores information corresponding to three-dimensional images in the storage unit 9. Other components are similar to those of Embodiment 1, and therefore, the same components assigned the same reference characters and descriptions thereof are omitted.

As shown in FIG. 14, the display operation device 1A displays a three-dimensional image 100 to the front of the three-dimensional image display unit 2A. The three-dimensional image display unit 2A displays the three-dimensional image 100 by the parallax barrier mode, and is constituted by a liquid crystal display panel, a parallax barrier, and the like. The three-dimensional image 100 is perceived by the user U to be floating in front of the display surface 2Aa of the three-dimensional image display unit 2Aa. The three-dimensional image display control unit 8A displays a prescribed three-dimensional image 100 in the three-dimensional image display unit 2A according to commands from the CPU 4. The three-dimensional image display control unit 8A may be a software function realized by the CPU 4 executing a control program stored in the ROM 5, or may be realized by a dedicated hardware circuit.

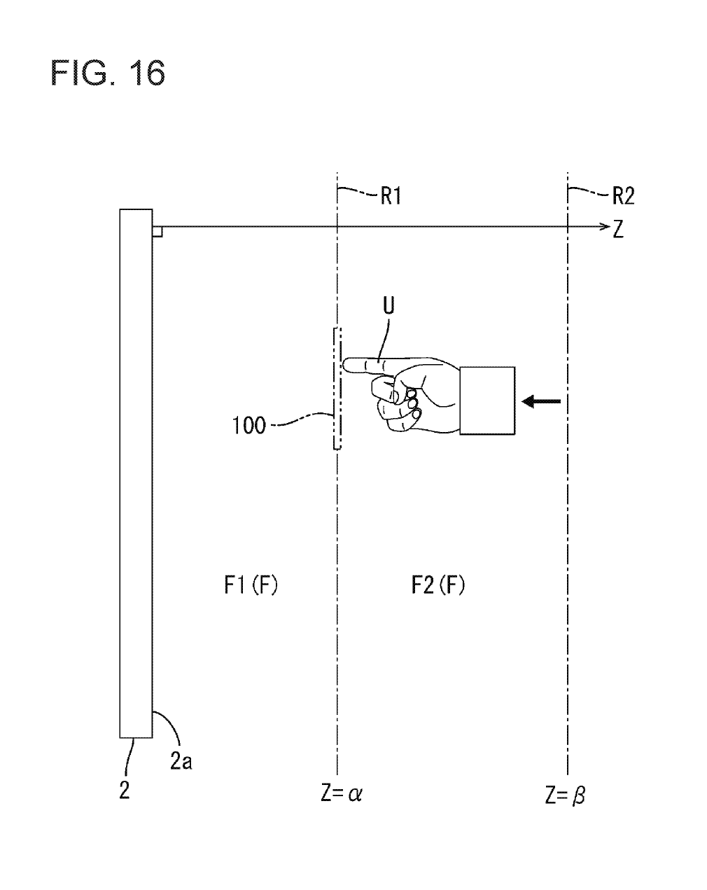

The display operation device 1A of the present embodiment also includes a finger position detection unit 3 similar to the above-mentioned display operation device 1, and as shown in FIG. 16, a detection region F similar to that of Embodiment 1 is formed to the front of the display operation device 1A. The three-dimensional image 100 is displayed at the first virtual plane R1 in front of the three-dimensional image display unit 2A. In other words, the three-dimensional image 100 is perceived by the user U to be floating 9 cm (Z=α) from the display surface 2Aa of the three-dimensional image display unit 2A.

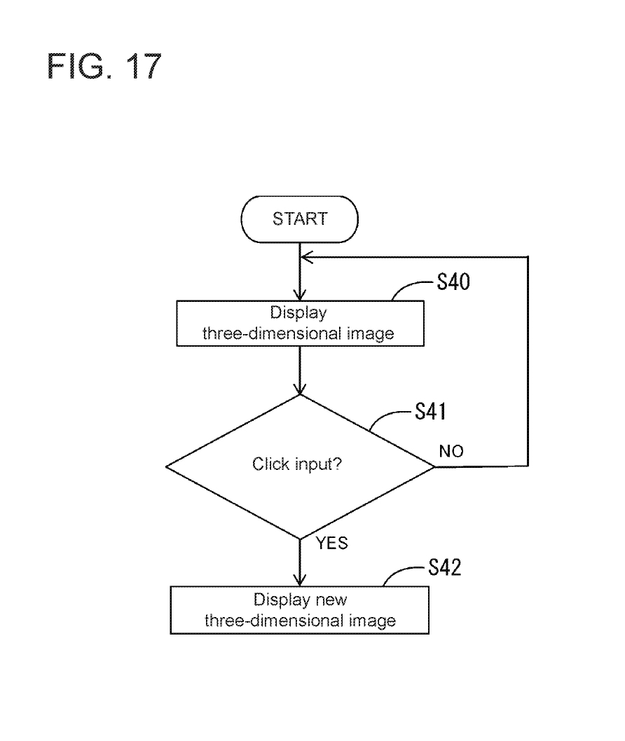

Next, the steps of the input process based on a click operation (single click operation) by the user U's fingertip will be described. FIG. 17 is a flowchart showing steps of an input process of the display operation device 1A based on a click operation by a fingertip.

First, in step S40, the user U performs a prescribed operation on the display operation device 1A, and causes the CPU 4 to execute a process in which the three-dimensional image display unit 2A displays the prescribed three-dimensional image 100 on the first virtual plane R1.

Next, in step S41, the CPU 4 determines whether or not there has been a click input. The processing content in step S41 is the same as the processing content for the click operation of Embodiment 1 (steps S10 to S16 in the flowchart of FIG. 5). However, in the case of the present embodiment, the user U can perform click input using the first virtual plane R1 while experiencing the sense of directly touching the three-dimensional image 100.

In step S41, if the CPU 4 determines that an input by click operation (single click operation) has been received, it progresses to step S42, and a new three-dimensional image (not shown) that has been placed in association with the click input in advance is displayed by the three-dimensional image display unit 2A. The three-dimensional image 100 of the rear surface of a playing card shown in FIG. 14 may be switched to the front surface of the playing card by click input, for example. In this manner, in the display operation device 1A, the three-dimensional image 100 displayed by the three-dimensional image display unit 2A is arranged on the first virtual plane R1 (click surface), and thus, it is possible for the user U to perform an input operation to switch to another three-dimensional image while experiencing the sense of directly touching the three-dimensional image 100 with his/her fingertip. In the display operation device 1 of Embodiment 1, it would be difficult for the user U to recognize the object to be operated (click surface of the first virtual plane R1), but such a problem is solved in the display operation device 1A of the present embodiment.

### OTHER EMBODIMENTS

The present invention is not limited to the embodiments shown in the drawings and described above, and the following embodiments are also included in the technical scope of the present invention, for example.

(1) In a display operation device of another embodiment, the display unit may include touch panel functionality. In other words, the display operation device may include both a non-contact-type input method and a contact-type input method.

(2) There is no special limitation on the arrangement of electrodes (transmitter electrode, receiver electrode) included in the capacitive sensor as long as a prescribed detection region as illustrated in the embodiments above can be formed to the front of the display unit (towards the user).

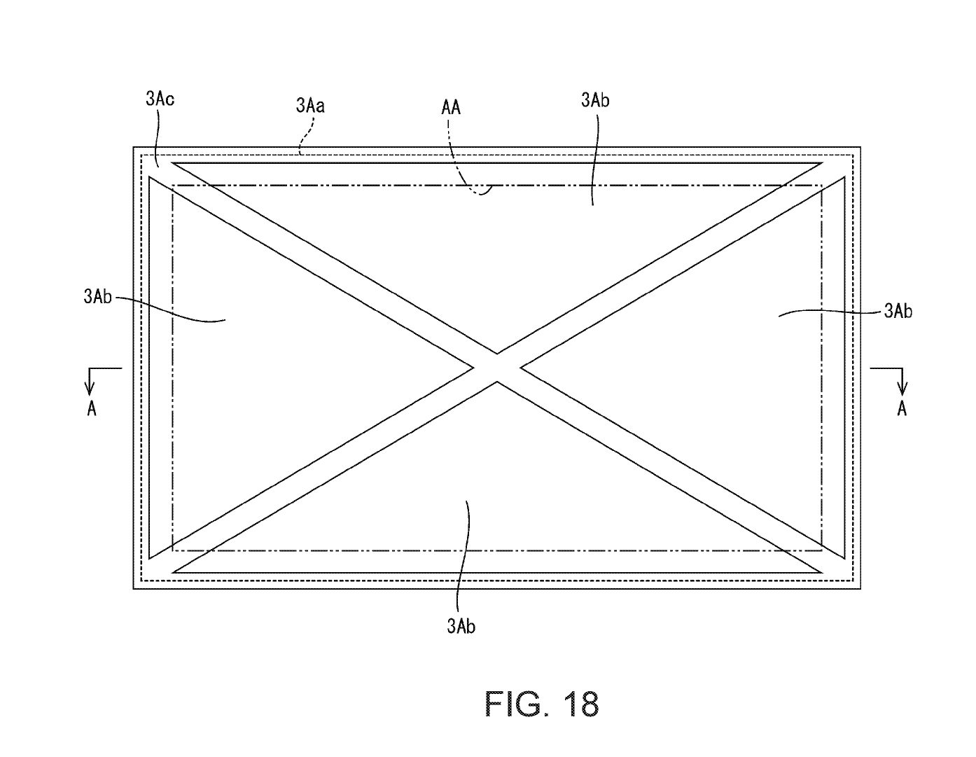

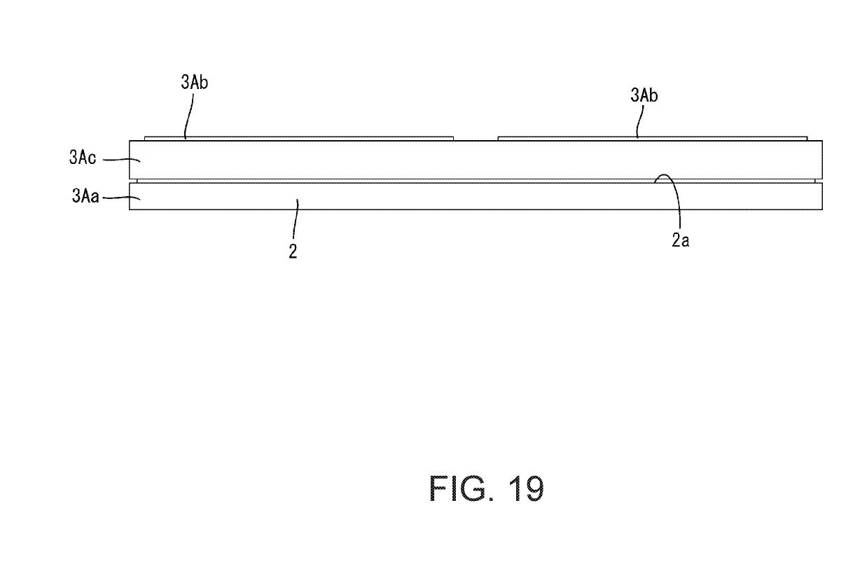

(3) FIG. 18 is a front view that schematically shows Modification Example 1 of electrodes 3Aa and 3Ab included in the capacitive sensor, and FIG. 19 is a cross-sectional view along the line A-A of FIG. 18. In Modification Example 1, one of the electrodes 3Aa (transmitter electrode) is arranged to overlap the display area AA (active area) of the display unit 2, and the other electrodes 3Ab (receiver electrodes) are arranged to overlap the electrode 3Aa across a transparent insulating layer 3Ac. The electrodes 3Ab are constituted by four parts, each of which is triangular in shape. The electrodes 3Aa and 3Ab may be arranged to overlap the display area AA as in Modification Example 1. In such a case, the electrode material forming the electrodes 3Aa and 3Ab would be a transparent conductive film.

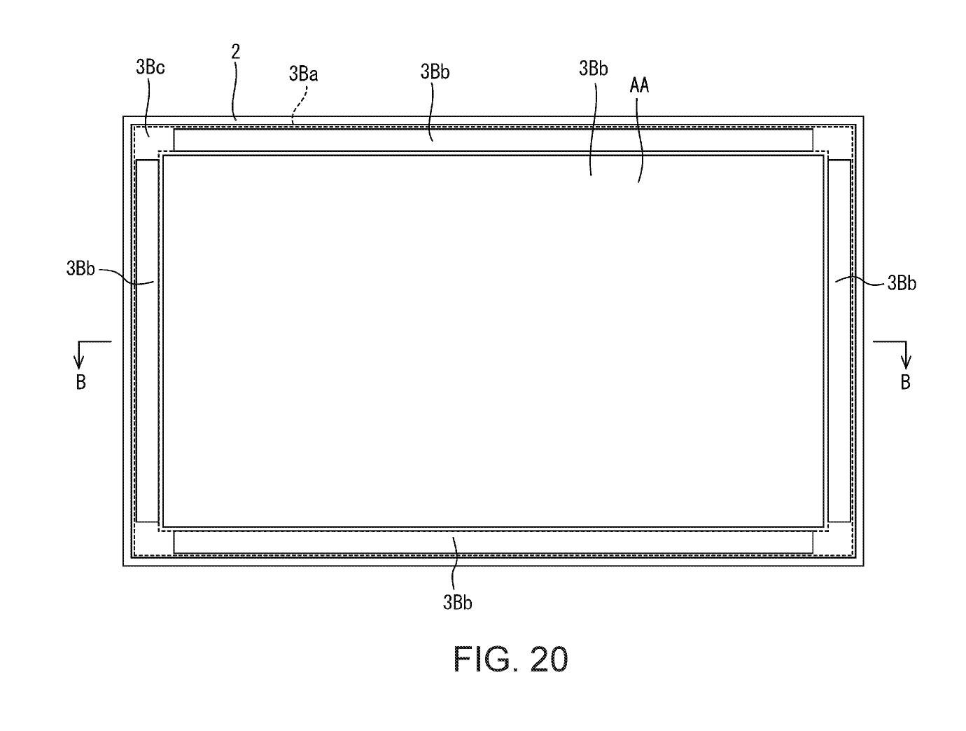

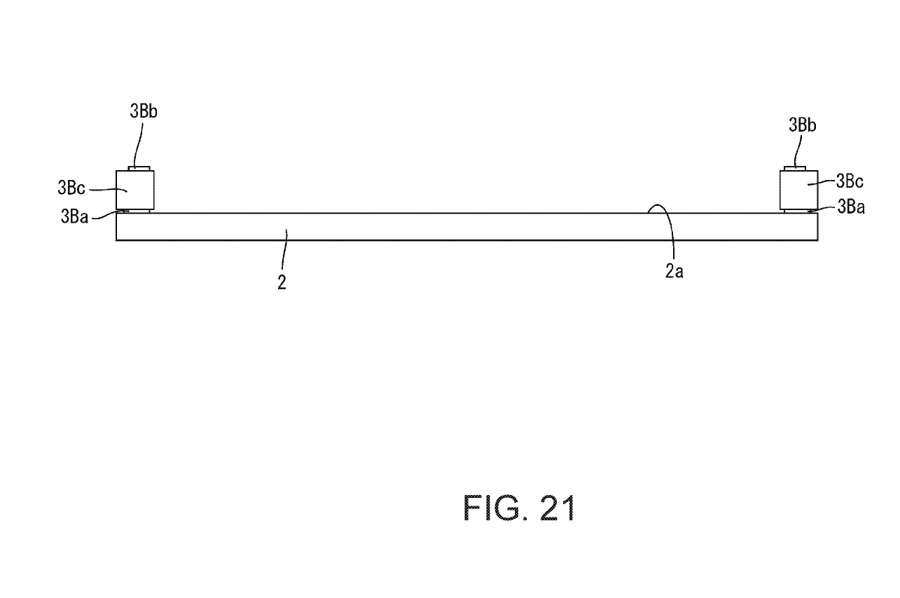

(4) FIG. 20 is a front view that schematically shows Modification Example 2 of electrodes 3Ba and 3Bb included in the capacitive sensor, and FIG. 21 is a cross-sectional view along the line B-B of FIG. 20. In Modification Example 2, one of the electrodes 3Ba (transmitter electrode) has a frame shape surrounding a display area AA (active area) of the display unit 2. In other words, the electrode 3Ba is arranged in the non-display area (frame region). A frame-shaped insulating layer 3Bc is formed on the electrode 3Ba. By contrast, the other electrodes 3Bb (receiver electrodes) are arranged so as to overlap the electrode 3Ba across an insulating layer 3Bc. The electrodes 3Bb form a frame shape overall, but include four portions that are disposed, respectively, at the sides of the rectangular display area AA. The electrodes 3Ba and 3Bb may be arranged only in the non-display area (frame region) surrounding the display area AA as in Modification Example 2.

(5) The display operation device of the embodiments received input operation by the finger position detection unit detecting the position coordinates of the user's hand (fingertip), but the present invention is not limited thereto, and in other embodiments, a detection object such as a stylus may be what is detected by the finger position detection unit.

(6) In the embodiments, the second virtual plane is set as the position in the Z axis direction where the signal strength was at the detection limit, but in other embodiments, the position of the second virtual plane may be set closer to the display operation device than the detection limit.

(7) There is no special limitation on the first virtual plane as long as the first virtual plane is set between the display surface (reference surface) of the display unit and the detection limit position in the Z axis direction. However, for purposes such as ensuring a large second detection region, it is preferable that the first virtual plane be set closer towards the display surface (display operation device) than the midway point between the display surface and the detection limit position. By setting the first virtual plane closer towards the display surface in this manner, it is easier for the user to move his/her fingertip in and out of the first detection region, and for the user to more easily perform an input operation (click operation) on the first virtual plane (click surface).

(8) In Embodiment 1, the displayed image was switched to an enlarged image by an input operation based on forward movement of the fingertip, and then by an input operation based on backward movement thereafter, the displayed image was switched to a shrunken image, but in other embodiments, a configuration may be adopted in which an input operation based on forward movement results in the displayed image being switched to a shrunken image, and an input operation based on backward movement results in the displayed image being switched to an enlarged image. Alternatively, forward and backward movement by a fingertip may be associated with a command to the display operation device to perform another process besides enlarging or shrinking the displayed image.

(9) In the embodiments, the displayed image was switched by an input operation based on fingertip movement, but in another embodiment, fingertip movement can result in a process for another component (such as volume adjustment for speakers) besides the switching of displayed images being executed.

(10) In the embodiments, only the Z coordinate was used among the acquired position coordinates P of the fingertip, and only fingertip movement in the Z axis direction was recognized, but in other embodiments, fingertip movement may be recognized using not only the Z coordinate but furthermore, as necessary, the X coordinate and Y coordinate. It is preferable that a capacitive sensor be used as the sensor for the finger position detection unit for reasons such as being able to detect with ease movement of the fingertip, which is the detection object, in the Z axis direction.

(11) In Embodiment 2, the three-dimensional image was switched to another three-dimensional image (static image) according to movement of the user's fingertip (click operation), but the present invention is not limited thereto, and the display operation device may be configured such that after receiving the fingertip movement (click operation) by the user, the three-dimensional image (such as a globe) undergoes movement such as rotation, for example. Furthermore, a configuration may be adopted in which a switch image is displayed as the three-dimensional image, with the user being able to recognize the image as a virtual switch.

### DESCRIPTION OF REFERENCE CHARACTERS

1 display operation device (input device)
2 display unit
2a display surface (reference surface)
3 finger position detection unit (position detection unit)
3a, 3b electrode
30 sensor
4 CPU (determination unit, comparison unit, standby detection unit, change amount detection unit)
5 ROM
6 RAM
7 timer
8 display control unit (display switching unit)
9 storage unit
10 bus line
F detection region
R1 first virtual plane (virtual plane)
R2 second virtual plane
U user
P position coordinate of detection object

1-10. (canceled)

11: An input device, comprising:
a position detection unit that defines a detection region in a space in front of a prescribed reference surface and detects a position coordinate in the detection region of a detection object that has entered the detection region for an input operation on a coordinate axis perpendicular to the reference surface; and
a processor that defines a virtual plane in parallel to the reference surface so as to partition the detection region in a direction of said coordinate axis, and that compares the position coordinate on said coordinate axis of the detection object as detected by the position detection unit with a position coordinate on said coordinate axis of said virtual plane, the processor further determining the input operation of the detection object in accordance with a result of said comparison.

12: The input device according to claim 11, wherein, when a comparison result by the processor indicates that the position coordinate of the detection object is less than or equal to the position coordinate of the virtual plane, the processor determines that the input operation is a click operation that passes through the virtual plane in a direction towards the reference surface.

13: An input device, comprising:
a position detection unit that defines a detection region in a space in front of a prescribed reference surface and detects a position coordinate in the detection region of a detection object that has entered the detection region for an input operation on a coordinate axis perpendicular to the reference surface; and
a processor configured to:
define a virtual plane that is parallel to the reference surface and that partitions the detection region in a direction of the coordinate axis such that the detection region is divided into a first detection region adjacent to the reference surface and a second detection region farther away from the reference surface than the first detection region;
detect that the detection object has stayed in the second detection region for a prescribed time in accordance with detection results of the position detection unit;
detect, in accordance with the detection results of the position detection unit, an amount of change in position of the detection object when the detection object moves from the second detection region to the first detection region only when the position detection unit has been determined to have stayed in the second detection region for the prescribed time; and
determine the input operation of the detection object in accordance with the detected amount of change in position of the detection object.

14: An input device, comprising:
a position detection unit that defines a detection region in a space in front of a prescribed reference surface and detects position coordinates in the detection region of a detection object that has entered the detection region for an input operation on a coordinate axis perpendicular to the reference surface; and
a processor configured to:
define a virtual plane that is parallel to the reference surface and that partitions the detection region in a direction of the coordinate axis such that the detection region is divided into a first detection region adjacent to the reference surface and a second detection region farther away from the reference surface than the first detection region;
detect that the detection object has stayed in the first detection region for a prescribed time in accordance with detection results of the position detection unit;
detect, in accordance with the detection results of the position detection unit, an amount of change in position of the detection object when the detection object moves from the first detection region to the second detection region only when the position detection unit has been determined to have stayed in the first detection region for the prescribed time; and
determine the input operation of the detection object in accordance with the detected amount of change in position of the detection object.

15: The input device according to claim 11, further comprising a display unit that displays images, wherein the reference surface is a display surface of the display unit.

16: The input device according to claim 15, wherein, when the processor determines the input operation, the processor causes the display unit to display an image corresponding to the input operation.

17: The input device according to claim 13, further comprising a display unit that displays images, wherein the reference surface is a display surface of the display unit.

18: The input device according to claim 14, further comprising a display unit that displays images, wherein the reference surface is a display surface of the display unit.

19: The input device according to claim 17, wherein, when the processor determines the input operation, the processor causes the display unit to display an image corresponding to the input operation.

20: The input device according to claim 18, wherein, when the processor determines the input operation, the processor causes the display unit to display an image corresponding to the input operation.

21: An input device, comprising:
a display unit that displays a three-dimensional image so as to float in front of a display surface as seen from a viewer;
a position detection unit that defines a detection region in a space in front of the display surface and detects a position coordinate in the detection region of a detection object that has entered the detection region for an input operation on a coordinate axis perpendicular to the display surface; and
a processor configured to:
define a virtual plane in parallel to the reference surface so as to partition the detection region in a direction of said coordinate axis, the defined virtual plane being located at or adjacent to a position of the three-dimensional image that floats in front of the display surface;
compare the position coordinate on said coordinate axis of the detection object as detected by the position detection unit with a position coordinate on said coordinate axis of said virtual plane; and
determine the input operation of the detection object in accordance with a result of said comparison.

22: The input device according to claim 21, wherein, when a comparison result by the processor indicates that the position coordinate of the detection object is less than or equal to the position coordinate in the virtual plane, the processor determines that the input operation is a click operation that passes through the virtual plane in a direction towards the reference surface.

23: The input device according to claim 21, wherein, when the processor determines the input operation, the processor causes the display unit to switch the three-dimensional image floating in front of the display surface of the display unit to another three-dimensional image corresponding to the input operation.

24: The input device according to claim 11, wherein the position detection unit includes a sensor having a pair of electrodes, forming the detection region by an electric field, so as to detect the position coordinate of the detection object on the basis of static capacitance between the electrodes.

25: The input device according to claim 13, wherein the position detection unit includes a sensor having a pair of electrodes, forming the detection region by an electric field, so as to detect the position coordinate of the detection object on the basis of static capacitance between the electrodes.

26: The input device according to claim 14, wherein the position detection unit includes a sensor having a pair of electrodes, forming the detection region by an electric field, so as to detect the position coordinate of the detection object on the basis of static capacitance between the electrodes.

27: The input device according to claim 21, wherein the position detection unit includes a sensor having a pair of electrodes, forming the detection region by an electric field, so as to detect the position coordinate of the detection object on the basis of static capacitance between the electrodes.
